(19) United States
(12) Patent Application Publication
(10) Pub. No.: US 2014/0016300 A1
(43) Pub. Date: Jan. 16, 2014

(54) LIGHT EMITTING DEVICE, ILLUMINATING APPARATUS, AND LIGHT EMITTING METHOD

(71) Applicant: Sharp Kabushiki Kaisha, Osaka (JP)

(72) Inventors: Rina SATO, Osaka-shi (JP); Katsuhiko KISHIMOTO, Osaka-shi (JP)

(21) Appl. No.: 13/938,448

(22) Filed: Jul. 10, 2013

(30) Foreign Application Priority Data
Jul. 13, 2012 (JP) 2012-158000

(51) Int. Cl. F21V 9/16

(52) U.S. Cl. CPC F21V 9/16
USPC 362/84

(57) ABSTRACT

A headlamp emits illumination light obtained by mixing a laser beam with fluorescent light. The headlamp includes a semiconductor laser that emits the laser beam and a light emitting unit including a fluorescent material that receives the laser beam and emits the fluorescent light. A peak wavelength of the laser beam emitted from the semiconductor laser is longer than a wavelength at which an external quantum efficiency of the fluorescent material is at a maximum.

This Nonprovisional application claims priority under 35 U.S.C. §119 on Patent Application No. 2012-158000 filed in Japan on Jul. 13, 2012, the entire contents of which are hereby incorporated by reference.

### BACKGROUND OF THE INVENTION

1. Field of the Invention

The present invention relates to light emitting devices using laser beams, and more particularly, to a light emitting device that uses light obtained by mixing a laser beam with fluorescent light as illumination light, the fluorescent light being obtained as a result of wavelength conversion of a part of the laser beam. The present invention also relates to an illuminating apparatus including the light emitting device and a light emitting method for the light emitting device.

2. Description of the Related Art

In recent years, light emitting devices have been proposed which include a laser diode (LD) as a light source and provide, for example, an illuminating function by using a laser beam emitted from the laser diode. In such a light emitting device that uses a laser beam, eye safety is ensured by controlling the intensity of the laser beam emitted to the outside, so that a human eye is prevented from being damaged when the laser beam reaches the eye.

With regard to a light emitting device that uses a laser beam, International Publication No. 2007/023916 (published on Mar. 1, 2007), for example, discloses a technology for ensuring eye safety in a projection display that emits a laser beam. According to this technique, power of a laser source is set so that an intensity A (mW/mm²) of a laser beam on an optical modulation element satisfies A<686×B², where B is a numerical aperture of an illumination optical system at an image side.

Japanese Unexamined Patent Application Publication No. 2002-045329 (published on Feb. 12, 2002) discloses a technology for ensuring eye safety in a fluorescent image display device that uses fluorescent light generated by irradiating a fluorescent material with a laser beam. According to this technique, emission of the laser beam from a laser source is stopped when power of the emitted laser beam reaches or exceeds a predetermined value.

However, in a light emitting device that emits desired illumination light by mixing a laser beam with fluorescent light, optical power of the laser beam that excites the fluorescent material needs to be increased in order to increase the luminous flux of the emitted illumination light. Therefore, according to the above-described techniques of the related art, it has been difficult to increase the luminous flux of the illumination light while ensuring safety.

### SUMMARY OF THE INVENTION

The present invention has been made in light of the above-described problems of the related art and an object of the present invention is to provide a light emitting device capable of emitting illumination light having a high luminous flux while ensuring safety, an illuminating apparatus including the light emitting device, and a light emitting method for the light emitting device.

To achieve the above-described object, a light emitting device according to an aspect of the present invention includes a laser source that emits a laser beam, and a light emitting unit including a fluorescent material that receives the laser beam emitted from the laser source and emits fluorescent light. The light emitting device emits illumination light including the laser beam and the fluorescent light. A peak wavelength of the laser beam emitted from the laser source is longer than a wavelength at which an external quantum efficiency of the fluorescent material is at a maximum.

In a light emitting device that emits illumination light having a desired chroma by mixing a laser beam with fluorescent light, the luminous flux of the illumination light may be increased by increasing the optical power (intensity) of a laser beam that excites a fluorescent material. On the other hand, from the viewpoint of eye safety, the optical power of the laser beam emitted to the outside is preferably low because there is a risk that the laser beam will damage a retina.

Therefore, in a light emitting device that emits illumination light including a laser beam, the optical power of the laser beam emitted to the outside is required to be less than or equal to an accessible emission limit, which is a limit of the optical power at which eye safety can be ensured. Accordingly, it has been difficult to sufficiently increase the luminous flux of the illumination light.

With regard to the light emitting device that emits the illumination light including the laser beam, as a result of intensive studies, the inventors of the present invention have found a new method for increasing the luminous flux of the illumination light by increasing the optical power of the laser beam that excites the fluorescent material while ensuring eye safety.

In general, when a laser beam is used as excitation light, an excitation wavelength at which luminous efficiency (external quantum efficiency) of the fluorescent material is at a maximum is selected in consideration of wavelength dependency of the external quantum efficiency. The optical power of the laser beam that excites the fluorescent material, the optical power determining the luminous flux of the illumination light, is controlled so that the optical power of the laser beam emitted to the outside is less than or equal to the above-described accessible emission limit.

In contrast, in the above-described structure, the fluorescent material is excited with a laser beam having a wavelength longer than an excitation wavelength at which the external quantum efficiency of the fluorescent material is at a maximum. Accordingly, the optical power of the laser beam that excites the fluorescent material can be increased while ensuring eye safety.

For example, a retina of a human eye is most easily damaged when irradiated with light having a wavelength in the range of 425 nm or more and 450 nm or less, irrespective of whether or not the light is a laser beam, that is, whether the light is coherent or incoherent. The retina is not easily damaged when irradiated with light having a wavelength that is shorter than 425 nm or longer than 450 nm.

Thus, safety of light on the retina has wavelength dependency. Therefore, safety of the laser beam included in the illumination light on the retina can be increased by, for example, exciting the fluorescent material with a laser beam having a wavelength longer than 450 nm. In such a case, the accessible emission limit at which eye safety can be ensured is higher than that in the case where the fluorescent material is excited with a laser beam having a wavelength of 450 nm. Accordingly, the optical power of the laser beam that excites the fluorescent material can be increased.

It has been found that the percentage by which the external quantum efficiency of the fluorescent material is reduced as a result of using the laser beam having a wavelength longer than the excitation wavelength at which the external quantum efficiency is at a maximum is several percent at most. In contrast, the accessible emission limit at which eye safety can be ensured increases several times. Thus, the advantage that safe illumination light having a high luminous flux can be obtained is far greater than the disadvantage caused by the reduction in the external quantum efficiency of the fluorescent material.

Thus, the light emitting device is capable of emitting illumination light having a high luminous flux while ensuring eye safety by exciting the fluorescent material with a laser beam having a wavelength longer than the excitation wavelength at which the external quantum efficiency is at a maximum.

As described above, the peak wavelength of the laser beam emitted from the laser source is set so as to be longer than the wavelength at which the external quantum efficiency of the fluorescent material included in the light emitting unit is at a maximum. Accordingly, compared to the case where the fluorescent material is excited with a laser beam having the excitation wavelength at which the external quantum efficiency of the fluorescent material is at a maximum, safety of the laser beam included in the illumination light can be increased. Therefore, safety of the illumination light can be ensured even when the optical power of the laser beam with which the light emitting unit is irradiated is increased.

According to the above-described structure, a light emitting device capable of emitting illumination light having a high luminous flux while ensuring safety can be provided.

In the light emitting device according to the aspect of the present invention, preferably, the fluorescent material is a YAG fluorescent material, and the peak wavelength of the laser beam is longer than 450 nm and shorter than or equal to 500 nm.

In general, the excitation wavelength at which the external quantum efficiency of the YAG fluorescent material is at a maximum is around 450 nm. Accordingly, light having a peak wavelength of 445 nm or 450 nm is generally used to excite the YAG fluorescent material.

With regard to this common general technical knowledge, the inventors of the present invention have found that reduction in the external quantum efficiency of the YAG fluorescent material is small and the external quantum efficiency can be maintained at a high level when the YAG fluorescent material is excited with a laser beam having a peak wavelength in the range of 430 nm or more and 500 nm or less. In other words, the inventors of the present invention have found that, even when a laser beam having a wavelength longer than 450 nm, at which the external quantum efficiency of the YAG fluorescent material is at a maximum, is used, the external quantum efficiency of the YAG fluorescent material is not reduced by a large amount.

When the YAG fluorescent material is excited by using a laser beam having a wavelength longer than 450 nm, safety of the laser beam included in the illumination light on the retina can be increased. Therefore, compared to the case in which the YAG fluorescent material is excited by using a laser beam having a wavelength of 450 nm, the accessible emission limit at which eye safety can be ensured can be increased. Thus, illumination light having a higher luminous flux can be emitted from the light emitting device while ensuring eye safety.

This new finding clearly shows that, when the YAG fluorescent material is excited with a laser beam having a peak wavelength that is longer than 450 nm and shorter than or equal to 500 nm, compared to the case in which the YAG fluorescent material is excited with light having a wavelength of 445 nm or 450 nm as in the related art, safer illumination light can be emitted while the external quantum efficiency of the YAG fluorescent material is maintained at a high level.

Therefore, according to the above-described structure, white illumination light that is safer than that according to the related art can be emitted even when the optical intensity is constant.

In the light emitting device according to the aspect of the present invention, preferably, the fluorescent material is a CASN fluorescent material, and the peak wavelength of the laser beam is longer than 450 nm and shorter than or equal to 530 nm.

In general, the excitation wavelength at which the external quantum efficiency of the CASN fluorescent material is at a maximum is in the range of 400 nm to 450 nm. Accordingly, light having a peak wavelength of 450 nm is generally used to excite the CASN fluorescent material.

With regard to this common general technical knowledge, the inventors of the present invention have found that reduction in the external quantum efficiency of the CASN fluorescent material is small and the external quantum efficiency can be maintained at a high level when the CASN fluorescent material is excited with a laser beam having a peak wavelength that is longer than 450 nm and shorter than or equal to 530 nm. In other words, the inventors of the present invention have found that, even when a laser beam having a wavelength longer than 450 nm, at which the external quantum efficiency of the CASN fluorescent material is at a maximum, is used, the external quantum efficiency of the CASN fluorescent material is not reduced by a large amount.

When the CASN fluorescent material is excited by using a laser beam having a wavelength longer than 450 nm, safety of the laser beam included in the illumination light on the retina can be increased. Therefore, compared to the case in which the CASN fluorescent material is excited by using a laser beam having a wavelength of 450 nm, the accessible emission limit at which eye safety can be ensured can be increased. Thus, illumination light having a higher luminous flux can be emitted from the light emitting device while ensuring eye safety.

This new finding clearly shows that, when the CASN fluorescent material is excited with a laser beam having a peak wavelength that is longer than 450 nm and shorter than or equal to 530 nm, compared to the case in which the CASN fluorescent material is excited with light having a wavelength of 450 nm as in the related art, safer illumination light can be emitted while the external quantum efficiency of the CASN fluorescent material is maintained at a high level.

Therefore, according to the above-described structure, white illumination light that is safer than that according to the related art can be emitted even when the optical intensity is constant.

In the light emitting device according to the aspect of the present invention, preferably, when the peak wavelength of the laser beam is longer than 450 nm and shorter than or equal to 500 nm, an integrated intensity of optical spectrum of the illumination light in a wavelength range of ±5 nm with respect to the peak wavelength of the laser beam is 3.9×10⁻⁵×C₃ W or less, where C₃=10^{0.02×(λ-450)} when the peak wavelength of the laser beam is λnm.

In the above-described structure, when the wavelength of the laser beam is longer than 450 nm and shorter than or equal to 500 nm, an integrated intensity of optical spectrum of the illumination light in a wavelength range of ±5 nm with respect to the wavelength of the laser beam is 3.9×10⁻⁵×C₃ W or less, where C₃=10^{0.02×(λ-450)}. Specifically, the optical power of the laser source is set so that the optical power of the laser beam included in the illumination light is about 39 μl or less when the wavelength of the laser beam is 450 nm, and about 390 μl or less when the wavelength of the laser beam is 500 nm.

Thus, the optical power of the laser beam that excites the fluorescent material can be increased while ensuring safety by appropriately changing the optical power of the laser source in accordance with the wavelength of the emitted laser beam within the above-described range.

Thus, according to the above-described structure, an illuminating apparatus capable of emitting safe illumination light having a high luminous flux can be provided.

Preferably, the light emitting device according to the aspect of the present invention further includes a filter member that transmits the illumination light while removing a part of a wavelength component of the laser beam included in the illumination light.

According to this structure, since the light emitting device further includes the filter member that transmits the illumination light while removing a part of a wavelength component of the laser beam included in the illumination light, the luminous energy of the laser beam emitted to the outside can be reduced to an arbitrary value.

Therefore, according to the above-described structure, safer illumination light can be emitted by controlling the luminous energy of the laser beam emitted to the outside.

To achieve the above-described object, an illuminating apparatus according to another aspect of the present invention includes the above-described light emitting device.

Since the above-described light emitting device is included, an illuminating apparatus capable of emitting illumination light having a high luminous flux while ensuring safety can be provided.

To achieve the above-described object, a light emitting method according to another aspect of the present invention is applied to a light emitting device including a laser source that emits a laser beam and a light emitting unit including a fluorescent material that receives the laser beam emitted from the laser source and emits fluorescent light, the light emitting device emitting illumination light including the laser beam and the fluorescent light, the light emitting method including exciting the fluorescent material with the laser beam that has a peak wavelength longer than a wavelength at which an external quantum efficiency of the fluorescent material is at a maximum.

The above-described method includes exciting the fluorescent material with the laser beam that has a peak wavelength longer than a wavelength at which an external quantum efficiency of the fluorescent material is at a maximum.

Therefore, compared to a method in which the fluorescent material is excited with a laser beam having an excitation wavelength at which the external quantum efficiency of the fluorescent material is at a maximum, safety of the laser beam included in the illumination light can be increased. Therefore, safety of the illumination light can be ensured even when the optical power of the laser beam with which the light emitting unit is irradiated is increased.

According to the above-described structure, a light emitting method by which illumination light having a high luminous flux can be emitted while ensuring safety can be provided.

Thus, according to the aspects of the present invention, a light emitting device, an illuminating apparatus, and a light emitting method can be provided by which illumination light that is safer than that according to the related art can be emitted even when the optical intensity is constant.

### BRIEF DESCRIPTION OF THE DRAWINGS

FIG. 1 is a sectional view illustrating the structure of a headlamp according to an embodiment of the present invention.

FIG. 2 is a schematic diagram illustrating the circuit structure of each semiconductor laser illustrated in FIG. 1.

FIG. 3 is a perspective view illustrating the basic structure of the semiconductor laser illustrated in FIG. 2.

FIG. 4A is a graph showing an example of an optical intensity distribution of a laser beam.

FIG. 4B is a graph showing an example of an optical intensity distribution of illumination light obtained when the laser beam illustrated in FIG. 4A is used to excite a fluorescent material.

FIG. 5 is a graph showing the degree of damage caused on a retina of a human eye when the retina absorbs light.

FIG. 6 is a graph showing the relationship between the wavelength of excitation light (laser) and the accessible emission limit (AEL) at which eye safety can be ensured.

FIG. 7 is a graph showing the external quantum efficiency, absorptance, and internal quantum efficiency of a YAG fluorescent material.

FIG. 8A is a perspective view illustrating the appearance of an LED downlight according to the related art.

FIG. 8B is a perspective view illustrating the appearance of a light emitting unit included in a laser downlight according to an embodiment of the present invention.

FIG. 9 is a sectional view of a ceiling on which the laser downlight is mounted.

FIG. 10 is a sectional view of the laser downlight.

FIG. 11 is a sectional view illustrating a modification of the manner in which the laser downlight is installed in FIG. 10.

FIG. 12 is a sectional view of a ceiling on which LED downlights according to the related art having the structure illustrated in FIG. 8A is mounted.

FIG. 13 is a table showing the specifications of the LED downlight according to the related art and the laser downlight illustrated in FIGS. 8A and 8B, respectively.

### DESCRIPTION OF THE PREFERRED EMBODIMENTS

### First Embodiment

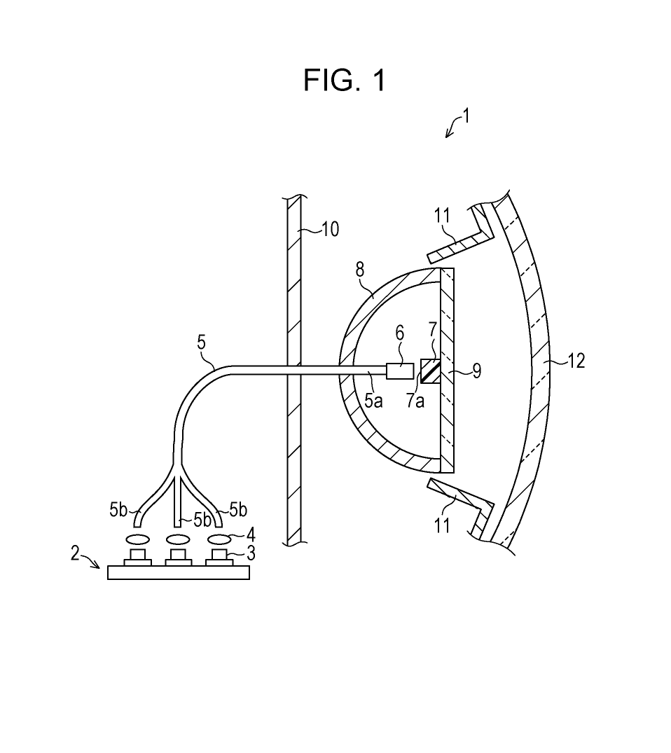

A first embodiment of the present invention will be described with reference to FIGS. 1 to 7. In the first embodiment, a headlamp (illuminating apparatus) 1 of an automobile including a light emitting device according to the present invention will be described.

However, the light emitting device according to the present invention may instead be installed in a headlamp for a vehicle or a moving object other than an automobile (for example, a human, a ship, an aircraft, a submarine, or a rocket), or in other illuminating apparatuses. Examples of other illuminating apparatuses include a searchlight, a projector, and indoor and outdoor illuminating apparatuses.

### Structure of Headlamp 1

The structure of the headlamp 1 will be described with reference to FIGS. 1 to 3. FIG. 1 is a sectional view illustrating the structure of the headlamp 1. As illustrated in FIG. 1, the headlamp 1 includes a semiconductor laser array 2, aspherical lenses 4, optical fibers 5, a ferrule 6, a light emitting unit 7, a reflecting mirror 8, a transparent plate (filter) 9, a housing 10, an extension 11, and a lens 12. Among these components, the semiconductor laser array 2, the optical fibers 5, the ferrule 6, and the light emitting unit 7 constitute the basic structure of the light emitting device.

The headlamp 1 emits illumination light obtained by mixing laser beams emitted from semiconductor lasers 3 included in the semiconductor laser array 2 with fluorescent light obtained as a result of wavelength conversion of parts of the laser beams.

The headlamp 1 may either satisfy light distribution characteristics standards for a traveling beam (high beam) or those for a passing beam (low beam).

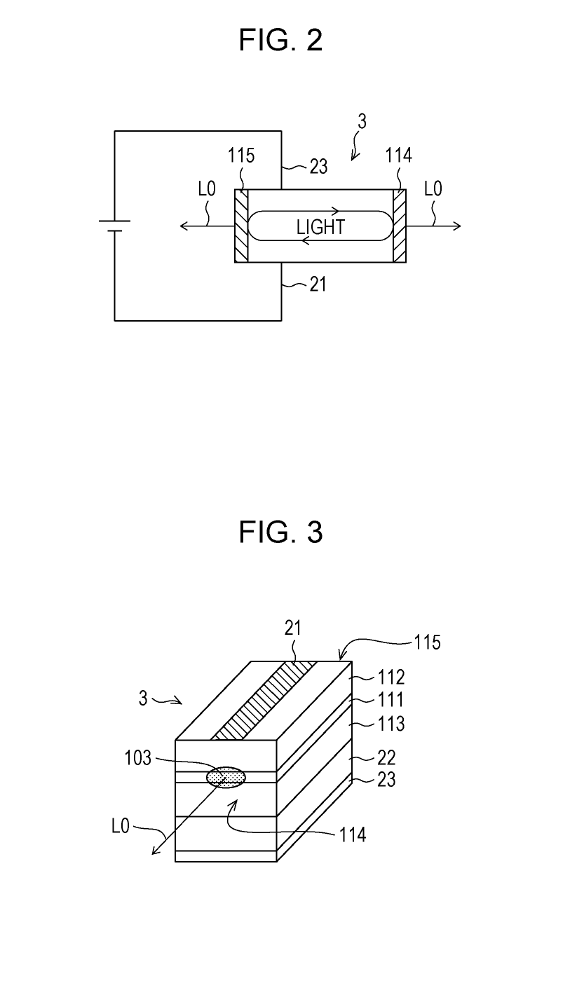

The components of the headlamp 1 will be further described with reference to FIGS. 2 and 3.

### Semiconductor Laser Array 2/Semiconductor Lasers 3

The semiconductor laser array 2 includes the semiconductor lasers (laser sources) 3 that emit laser beams and that are arranged on a substrate. A laser-beam irradiation surface 7a of the light emitting unit 7 is irradiated with the laser beams emitted from the respective semiconductor lasers 3. Parts of the laser beams with which the light emitting unit 7 has been irradiated are converted into fluorescent light by a fluorescent material included in the light emitting unit 7.

It is not necessary to use a plurality of semiconductor lasers 3, and a single semiconductor laser 3 may instead be used. However, it is preferable to use a plurality of semiconductor lasers 3 to obtain a high-power laser beam.

FIG. 2 is a schematic diagram illustrating the circuit structure of each semiconductor laser 3 illustrated in FIG. 1. FIG. 3 is a perspective view illustrating the basic structure of the semiconductor laser 3 illustrated in FIG. 2. Referring to FIGS. 2 and 3, the semiconductor laser 3 includes a cathode electrode 23, a substrate 22, a cladding layer 113, an active layer 111, a cladding layer 112, and an anode electrode 21, which are stacked in that order.

The substrate 22 is a semiconductor substrate. To obtain, for example, a blue laser beam, the substrate 22 is preferably made of GaN, sapphire, or SiC. Other examples of the material of the semiconductor substrate include group IV semiconductors, such as Si, Ge, and SiC, group III-V compound semiconductors, such as GaAs, GaP, InP, AlAs, GaN, InN, InSb, GaSb, and AlN, group II-VI compound semiconductors, such as ZnTe, ZeSe, ZnS, and ZnO, oxide insulators, such as ZnO, Al₂O₃, SiO₂, TiO₂, CrO₂, and CeO₂, and nitride insulators, such as SiN.

The anode electrode 21 is provided to apply a current to the active layer 111 through the cladding layer 112.

The cathode electrode 23 is provided to apply a current to the active layer 111 through the cladding layer 113 from below the substrate 22. The current is applied by applying a forward bias between the anode electrode 21 and the cathode electrode 23.

The active layer 111 is sandwiched between the cladding layer 113 and the cladding layer 112.

To obtain a blue laser beam, a mixed crystal semiconductor made of AlInGaN is used as the material of the active layer 111 and the cladding layer 113. In general, an active layer and a cladding layer included in a semiconductor laser 3 are made of a mixed crystal semiconductor which mainly contains Al, Ga, In, As, P, N, and Sb, and such a material may instead be used. Alternatively, a group II-VI compound semiconductor containing Zn, Mg, S, Se, Te, or ZnO may be used.

The active layer 111 is a region in which light is generated in response to the applied current. The generated light is trapped in the active layer 111 owing to the difference in refractive index between the cladding layer 112 and the cladding layer 113.

The active layer 111 has a front cleavage surface 114 and a back cleavage surface 115 that oppose each other to trap the light amplified by induced emission. The front cleavage surface 114 and the back cleavage surface 115 function as mirrors.

However, unlike mirrors that fully reflect light, parts of the light amplified by induced emission are emitted through the front cleavage surface 114 and the back cleavage surface 115 of the active layer 111 as laser beams L0. In the first embodiment, most part of the laser beams L0 is emitted through the front cleavage surface 114. The active layer 111 may have a multiple quantum well structure.

A reflective film (not shown) for oscillating a laser beam is formed on the back cleavage surface 115 that opposes the front cleavage surface 114. The front cleavage surface 114 and the back cleavage surface 115 have different reflectances, so that one of the cleavage surfaces having a lower reflectance, for example, the front cleavage surface 114, emits most part of the laser beams L0 through a light emitting point 103.

The cladding layer 113 and the cladding layer 112 may be made of any semiconductor selected from group III-V compound semiconductors, such as n-type and p-type GaAs, GaP, InP, AlAs, GaN, InN, InSb, GaSb, and AlN, and group II-VI compound semiconductors, such as n-type and p-type ZnTe, ZeSe, ZnS, and ZnO. A current is applied to the active layer 111 by applying a forward bias between the anode electrode 21 and the cathode electrode 23.

The semiconductor layers, such as the cladding layer 113, the cladding layer 112, and the active layer 111, may be formed by a common deposition method such as metal organic chemical vapor deposition (MOCVD), molecular beam epitaxy (MBE), chemical vapor deposition (CVD), laser ablation, or sputtering. The metal layers may be formed by a common deposition method such as vacuum deposition, plating, laser ablation, or sputtering.

The laser beams emitted from the respective semiconductor lasers 3 are spatially and temporally in phase, and have a single wavelength. Therefore, the fluorescent material included in the light emitting unit 7 may be efficiently excited by using the laser beams as excitation light. As a result, high-brightness illumination light can be obtained.

The wavelength and optical power of the laser beams emitted from the semiconductor lasers 3 are set as appropriate in accordance with the type of the fluorescent material included in the light emitting unit 7. For example, laser beams within a wavelength range of a blue laser beam (455 nm) or a green laser beam (525 nm, 530 nm) may be selected.

In the headlamp 1, the peak wavelength of the laser beam emitted from each semiconductor laser 3 is set so as to be longer than a wavelength at which an external quantum efficiency of the fluorescent material included in the light emitting unit 7 is at a maximum. Accordingly, safety of the laser beam included in the illumination light can be improved, so that safety of the illumination light can be ensured even when the optical power of the laser beams with which the light emitting unit 7 is irradiated is increased. The setting of the wavelength and optical power of the laser beams emitted from the semiconductor lasers 3 will be described in detail below.

### Aspherical Lenses 4

The aspherical lenses 4 cause the laser beams emitted from the respective semiconductor lasers 3 to be incident on respective inlet ends 5b at one end of the optical fibers 5. Although the shape and material of the aspherical lenses 4 are not particularly limited, the aspherical lenses 4 are preferably made of a material having a high transmittance with respect to the laser beams emitted from the semiconductor lasers 3 and a high heat resistance.

### Optical Fibers 5

The optical fibers 5 are light guiding members that guide the laser beams emitted from the semiconductor lasers 3 to the light emitting unit 7, and are arranged in a bundle. The optical fibers 5 have the inlet ends 5b which receive the laser beams and outlet ends 5a from which the laser beams received by the inlet ends 5b are emitted. The laser beams are emitted from the outlet ends 5a toward different regions of the laser-beam irradiation surface 7a.

For example, the outlet ends 5a of the optical fibers 5 are arranged along a plane parallel to the laser-beam irradiation surface 7a. According to this arrangement, regions corresponding to the maximum optical intensity in the optical intensity distributions of the laser beams emitted from the outlet ends 5a (central regions (maximum optical intensity regions) of the irradiation areas in which the laser-beam irradiation surface 7a is irradiated with the laser beams) are at different locations on the laser-beam irradiation surface 7a of the light emitting unit 7. Thus, the laser beams may be two-dimensionally dispersed over the laser-beam irradiation surface 7a of the light emitting unit 7.

Therefore, the risk that the light emitting unit 7 will be locally irradiated with the laser beams and a part of the light emitting unit 7 will be significantly degraded can be reduced.

It is not necessary that the plurality of optical fibers 5 having the respective outlet ends 5a be arranged in a bundle, and the number of outlet ends 5a may instead be one.

Each optical fiber 5 has a two-layer structure in which a center core is covered with a clad having a refractive index lower than that of the core. The core is mainly made of quartz glass (silicon oxide) which causes an extremely small absorption loss in a laser beam. The clad is mainly made of quartz glass or a synthetic resin having a refractive index lower than that of the core. For example, each optical fiber 5 may have a core diameter of 200 μm, a clad diameter of 240 μm, and a numerical aperture (NA) of 0.22, and is made of quartz. However, the structure, thickness, and material of each optical fiber 5 are not limited to the above, and each optical fiber 5 may instead have a rectangular cross section along a plane perpendicular to the longitudinal axis of the optical fiber 5.

The optical fibers 5 are flexible, so that the arrangement of the outlet ends 5a with respect to the laser-beam irradiation surface 7a of the light emitting unit 7 can be easily changed. Therefore, the outlet ends 5a can be arranged in accordance with the shape of the laser-beam irradiation surface 7a of the light emitting unit 7, and the entire area of the laser-beam irradiation surface 7a of the light emitting unit 7 can be irradiated with the laser beams.

Since the optical fibers 5 are flexible, the positional relationship between the semiconductor lasers 3 and the light emitting unit 7 can be easily changed. In addition, the semiconductor lasers 3 may be arranged at a location separated from the light emitting unit 7 by adjusting the length of the optical fibers 5.

Accordingly, the degree of freedom in designing the headlamp 1 can be increased. For example, the semiconductor lasers 3 may be disposed at a location where the semiconductor lasers 3 can be easily cooled or replaced. In other words, the positional relationship between the semiconductor lasers 3 and the light emitting unit 7 can be easily changed by changing the positional relationship between the inlet ends 5b and the outlet ends 5a. Thus, the degree of freedom in designing the headlamp 1 can be increased.

Members other than the optical fibers 5 or combinations of the optical fibers 5 and other members may instead be used as the light guiding members. For example, one or more light-guiding members which each has a truncated cone shape or a truncated pyramid shape and includes an inlet end and an outlet end for a laser beam may be used.

### Ferrule 6

The ferrule 6 holds the outlet ends 5a of the optical fibers 5 in a predetermined pattern with respect to the laser-beam irradiation surface 7a of the light emitting unit 7. The ferrule 6 may have holes through which the outlet ends 5a are to be inserted and which are arranged in a predetermined pattern. Alternatively, the ferrule 6 may include upper and lower sections that can be separated from each other, and the outlet ends 5a may be clamped between grooves formed in opposing surfaces of the upper and lower sections.

The ferrule 6 may be fixed to the reflecting mirror 8 by, for example, a rod-shaped or cylindrical member that extends from the reflecting mirror 8. The material of the ferrule 6 is not particularly limited, and may be, for example, stainless steel. A plurality of ferrules 6 may be arranged for a single light emitting unit 7.

In the case where there is only one optical fiber 5 including the outlet end 5a, the ferrule 6 may be omitted. However, the ferrule 6 is preferably provided to reliably fix the position of the outlet end 5a with respect to the laser-beam irradiation surface 7a.

### Light Emitting Unit 7

The light emitting unit 7 emits light upon receiving the laser beams emitted from the outlet ends 5a of the optical fibers 5, and includes a fluorescent material that emits fluorescent light upon receiving the laser beams. Specifically, the light emitting unit 7 is formed by dispersing the fluorescent material into a silicone resin that serves as a fluorescent material holder. The ratio of the silicone resin to the fluorescent material is, for example, about 10 to 1. The light emitting unit 7 may instead be formed by compression molding of the fluorescent material. The fluorescent material holder is not limited to a silicone resin, and may instead be so-called inorganic-organic hybrid glass or inorganic glass.

The fluorescent material included in the light emitting unit 7 may be, for example, a YAG fluorescent material, an oxynitride fluorescent material, a nitride fluorescent material, or a semiconductor nanoparticle fluorescent material containing nanometer-sized particles of a group III-V compound semiconductor.

A so-called SiAlON fluorescent material is an example of an oxynitride fluorescent material. The SiAlON fluorescent material is a substance in which some silicon atoms and some nitrogen atoms included in silicon nitride are replaced by aluminum atoms and oxygen atoms, respectively. The SiAlON fluorescent material is a solid solution obtained by dissolving alumina (Al₂O₃), silica (SiO₂), a rare earth element, etc., into silicon nitride (Si₃N₄).

Examples of nitride fluorescent materials include a CASN (CaAlSiN₃) fluorescent material and a SCASN ((Sr,Ca)AlSiN₃) fluorescent material.

The YAG fluorescent material, oxynitride fluorescent material, and nitride fluorescent material have thermal stabilities higher than those of other fluorescent materials. Therefore, even when the fluorescent material is mixed with glass powder and subjected to a heating process to produce the light emitting unit 7, the fluorescent material does not undergo a change in composition and is mixed into the glass in a stable state. As a result, the light emitting unit 7 having a high luminous efficiency can be obtained.

The semiconductor nanoparticle fluorescent material containing nanometer-sized particles of a group III-V compound semiconductor is another preferred example of the fluorescent material.

One of the characteristics of the semiconductor nanoparticle fluorescent material is that even when a single type of compound semiconductor (for example, GaN) is used, luminescent color can be changed by the quantum size effect by changing the particle diameter in the nanometer order.

In addition, since the semiconductor nanoparticle fluorescent material is semiconductor based, lifetime of the emitted fluorescent light is short and the power of the excitation light can be radiated as the fluorescent light in a short time. Therefore, the semiconductor nanoparticle fluorescent material has a high resistance to high-power excitation light. This is because the emission lifetime of the semiconductor nanoparticle fluorescent material is about 10 nanoseconds, which is shorter by five orders of magnitude than that of an ordinary fluorescent material in which a rare earth element serves as the luminescent center.

Furthermore, absorption of the laser beams and the emission of light from the fluorescent material can be rapidly repeated because the emission lifetime is short as described above. As a result, the luminous efficiency can be maintained at a high level and heat radiated from the fluorescent material can be reduced even when the laser beams are strong.

Accordingly, deterioration (color change and deformation) of the light emitting unit 7 due to heat can be suppressed. Even when a light emitting element having a high optical power is used as a light source, reduction in lifetime of the light emitting device can be suppressed.

In Japan, illumination light emitted from a vehicle headlamp is regulated by law, and is required to have a white color with a chroma that is within a predetermined range. Accordingly, a laser beam and a fluorescent material are combined as appropriate so that white illumination light can be emitted from the headlamp 1. For example, when the light emitting unit 7 includes a yellow fluorescent material (for example, a YAG fluorescent material) and is irradiated with blue laser beams, the blue laser beams and yellow fluorescent light are mixed so that white illumination light is generated.

The light distribution pattern of the headlamp 1 is narrow in the vertical direction and wide in the horizontal direction. Therefore, the statutory distribution pattern can be easily achieved by forming the light emitting unit 7 in a horizontally long shape (substantially rectangular shape in cross section). In the first embodiment, the light emitting unit 7 has, for example, a rectangular parallelepiped shape with a size of 3 mm×1 mm×1 mm. In this case, the area of the laser-beam irradiation surface 7a that receives the laser beams from the semiconductor lasers 3 is 3 mm².

However, it is not necessary that the light emitting unit 7 have a rectangular parallelepiped shape, and the light emitting unit 7 may instead have a columnar shape in which the laser-beam irradiation surface 7a is elliptical. It is also not necessary that the laser-beam irradiation surface 7a be flat, and the laser-beam irradiation surface 7a may instead be curved. However, to control the reflection of the laser beams, the laser-beam irradiation surface 7a is preferably flat and perpendicular to the optical axes of the laser beams.

The light emitting unit 7 is fixed to an inner surface of the transparent plate 9 (surface on the side at which the outlet ends 5a are located) at a position where the light emitting unit 7 faces the outlet ends 5a. A method for fixing the position of the light emitting unit 7 is not limited to this, and the position of the light emitting unit 7 may instead be fixed by using a rod-shaped or cylindrical member that extends from the reflecting mirror 8.

### Reflecting Mirror 8

The reflecting mirror 8 reflects the light emitted from the light emitting unit 7 to form a bundle of rays that travel within a predetermined solid angle. In other words, the reflecting mirror 8 reflects the illumination light (laser beam and fluorescent light) emitted from the light emitting unit 7 to form a bundle of rays that travel toward a region in front of the headlamp 1. The reflecting mirror 8 may either be a metal member or a member in which a thin metal film is formed along a reflective curved surface.

The reflecting mirror 8 may be, for example, a full parabolic mirror having an opening with a closed circular shape or a half parabolic mirror having a semicircular opening. Alternatively, the reflecting mirror 8 may be a mirror having an elliptical or free-form surface or a multi-facet mirror (multireflector) instead of a parabolic mirror. The reflecting mirror 8 may include a region that is not curved.

### Transparent Plate 9

The transparent plate 9 is a transparent resin plate that covers the opening of the reflecting mirror 8 and holds the light emitting unit 7. The transparent plate 9 transmits the illumination light emitted from the light emitting unit 7 while removing a part of a wavelength component of the laser beam included in the illumination light. By removing a part of a wavelength component of the laser beam included in the illumination light, the luminous energy of the laser beam emitted to the outside can be reduced to an arbitrary value.

Therefore, safety of the emitted illumination light can be improved by installing the transparent plate 9 and controlling the luminous energy of the laser beam emitted to the outside.

The headlamp 1 emits the illumination light having the desired chroma by mixing the laser beam with the fluorescent light. Therefore, the transparent plate 9 removes a part of the laser beam included in the illumination light within a range in which the desired chroma can be achieved.

### Housing 10

The housing 10 serves as a main body of the headlamp 1, and contains the reflecting mirror 8 and other components. The optical fibers 5 extend through the housing 10, and the semiconductor laser array 2 is disposed outside the housing 10. Although the semiconductor lasers 3 generate heat during the emission of the laser beams, the semiconductor lasers 3 can be efficiently cooled because they are disposed outside the housing 10. Therefore, degradation of properties and thermal damage of the light emitting unit 7 due to the heat generated by the semiconductor lasers 3 can be suppressed.

### Extension 11

The extension 11 is provided at a side of the reflecting mirror 8 at which the opening is formed, and blocks the inner structure of the headlamp 1 to improve the appearance of the headlamp 1 and integrate the reflecting mirror 8 with the vehicle body. Similar to the reflecting mirror 8, the extension 11 may either be a metal member or a member in which a thin metal film is formed along a reflective curved surface.

### Lens 12

The lens 12 is provided so as to cover an opening in the housing 10 and seal the inside of the headlamp 1. The fluorescent light generated by the light emitting unit 7 and reflected by the reflecting mirror 8 passes through the lens 12 and is emitted toward a region in front of the headlamp 1.

### Setting of Wavelength and Optical Power of Laser Beams

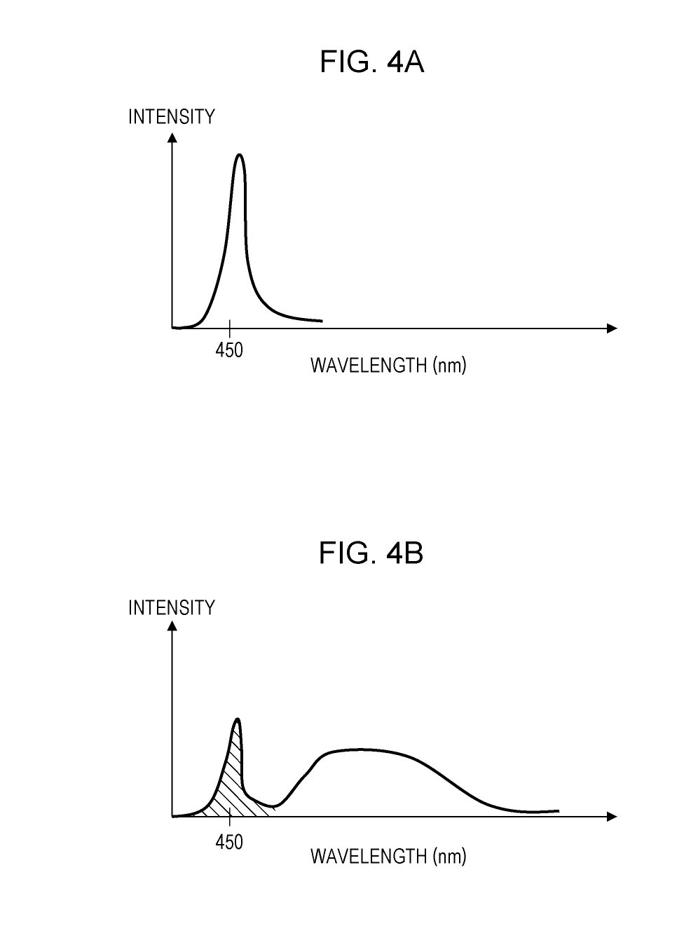

Setting of the wavelength and optical power of the laser beams emitted from the semiconductor lasers 3 will now be described with reference to FIGS. 4A to 7.

In the headlamp 1 that emits the illumination light having a desired chroma by mixing laser beams with fluorescent light, the luminous flux of the illumination light may be increased by increasing the optical power of the laser beams that excite the fluorescent material. On the other hand, from the viewpoint of eye safety, the optical power of the laser beam emitted to the outside is preferably low because there is a risk that the laser beam will damage a retina.

FIG. 4A is a graph showing an example of an optical intensity distribution of a laser beam. FIG. 4B is a graph showing an example of an optical intensity distribution of illumination light obtained when the laser beam illustrated in FIG. 4A is used to excite a fluorescent material. Referring to FIG. 4A, when an arbitrary fluorescent material is excited with a laser beam having a peak wavelength of 450 nm, a part of the laser beam is converted into fluorescent light by the fluorescent material. Therefore, as illustrated in FIG. 4B, illumination light in which the laser beam (shaded area in FIG. 4B) and the fluorescent light are mixed is obtained. When the illumination light having this light intensity distribution is emitted to the outside, there is a risk that the laser beam included in the illumination light will damage a retina of a human eye, as described below.

Therefore, in a light emitting device that emits illumination light including a laser beam, the optical power of the laser beam emitted to the outside is required to be less than or equal to an accessible emission limit, which is a limit of the optical power at which eye safety can be ensured. Accordingly, it has been difficult to sufficiently increase the luminous flux of the illumination light.

With regard to the headlamp 1 that emits the illumination light including the laser beam, as a result of intensive studies, the inventors of the present invention have found a new method for increasing the luminous flux of the illumination light by increasing the optical power of the laser beam that excites the fluorescent material while ensuring eye safety.

In general, when a laser beam is used as excitation light, an excitation wavelength at which luminous efficiency (external quantum efficiency) of the fluorescent material is at a maximum is selected in consideration of wavelength dependency of the external quantum efficiency. The optical power (intensity) of the laser beam that excites the fluorescent material, the optical power determining the luminous flux of the illumination light, is controlled so that the optical power of the laser beam emitted to the outside is less than or equal to the above-described accessible emission limit.

In contrast, in the headlamp 1, the fluorescent material is excited with laser beams which each have a wavelength longer than an excitation wavelength at which the external quantum efficiency of the fluorescent material is at a maximum (exciting step). Accordingly, the optical power of each laser beam that excites the fluorescent material can be increased while ensuring eye safety.

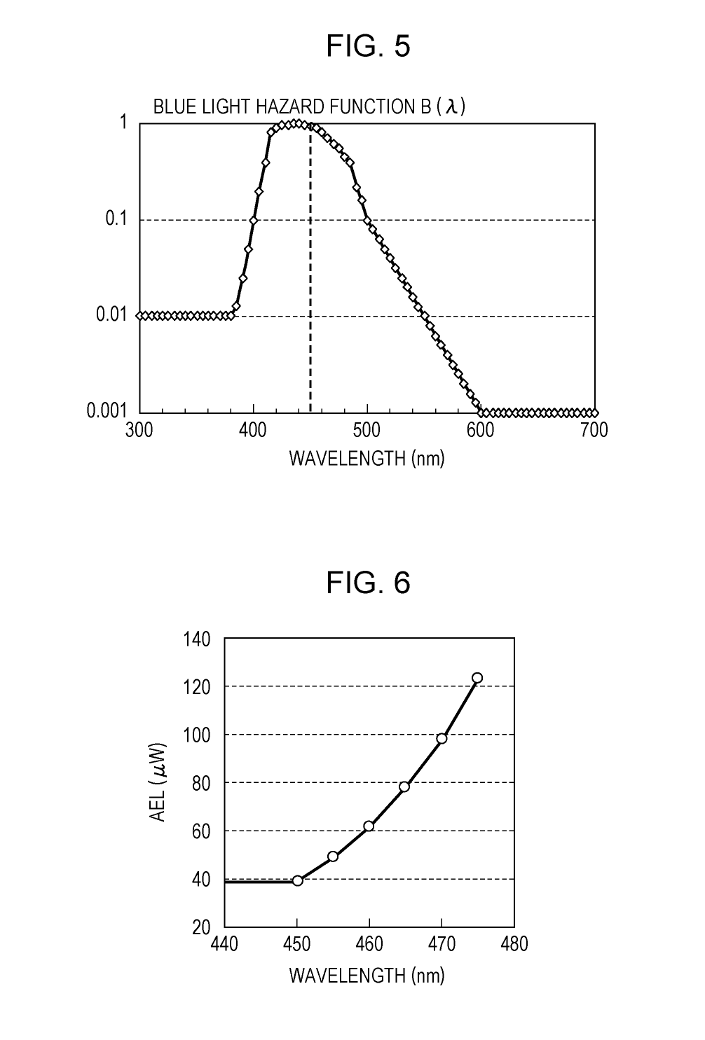

FIG. 5 is a graph showing the degree of damage caused on a retina of a human eye when the retina absorbs light. As is clear from FIG. 5, a retina of a human eye is most easily damaged when irradiated with light having a wavelength in the range of 425 nm or more and 450 nm or less, irrespective of whether or not the light is a laser beam, that is, whether the light is coherent or incoherent. The retina is not easily damaged when irradiated with light having a wavelength that is shorter than 425 nm or longer than 450 nm.

Thus, safety of light on the retina has wavelength dependency. Therefore, safety of the laser beam included in the emitted illumination light on the retina can be increased by, for example, exciting the fluorescent material with a laser beam having a wavelength longer than 450 nm. In such a case, the accessible emission limit at which eye safety can be ensured is higher than that in the case where the fluorescent material is excited with a laser beam having a wavelength of 450 nm. Accordingly, the optical power of the laser beam that excites the fluorescent material can be increased.

The percentage by which the external quantum efficiency of the fluorescent material is reduced as a result of using the laser beam having a wavelength longer than the excitation wavelength at which the external quantum efficiency is at a maximum is several percent at most. In contrast, the accessible emission limit at which eye safety can be ensured increases several times.

FIG. 6 is a graph showing the relationship between the wavelength of the excitation light and the accessible emission limit (AEL) at which eye safety can be ensured. As is clear from FIG. 6, the accessible emission limit at which eye safety can be ensured can be increased by setting the excitation wavelength to a wavelength longer than 450 nm. This is because when the fluorescent material is excited with a laser beam having a wavelength longer than 450 nm, safety of the laser beam included in the illumination light on the retina can be increased, so that safety can be ensured even when the accessible emission limit is increased.

The accessible emission limit is set so that an integrated intensity of optical spectrum of the illumination light in a wavelength range of ±5 nm with respect to the excitation wavelength is less than or equal to 3.9×10⁻⁵×C₃ W, where C₃=10^{0.02(λ-450)}. When, for example, the excitation wavelength is 450 nm, the accessible emission limit is about 39 μW. When the wavelength of light is 500 nm, the accessible emission limit is about 390 μW, which is about ten times that in the case where the excitation wavelength is 450 nm.

Thus, the advantage that safe illumination light having a high luminous flux can be obtained is far greater than the disadvantage caused by the reduction in the external quantum efficiency of the fluorescent material.

Thus, the headlamp 1 is capable of emitting illumination light having a high luminous flux while ensuring eye safety by exciting the fluorescent material with laser beams which each have a wavelength longer than the excitation wavelength at which the external quantum efficiency is at a maximum. When the fluorescent material is excited with laser beams which each have a wavelength longer than the excitation wavelength at which the external quantum efficiency is at a maximum and lower than or equal to a wavelength at which luminosity is at a peak, the luminous flux of the illumination light can be increased even when the radiant flux is constant.

### Operative Example 1

In the case where the fluorescent material included in the light emitting unit 7 is a YAG fluorescent material (Y_{1-x-y}GdₓCe_{y})₃Al₅O₁₂ (0.1≦x≦0.55, 0.01≦y≦0.4), the peak wavelength of the laser beam emitted from each semiconductor laser 3 is preferably longer than 450 nm and shorter than or equal to 500 nm.

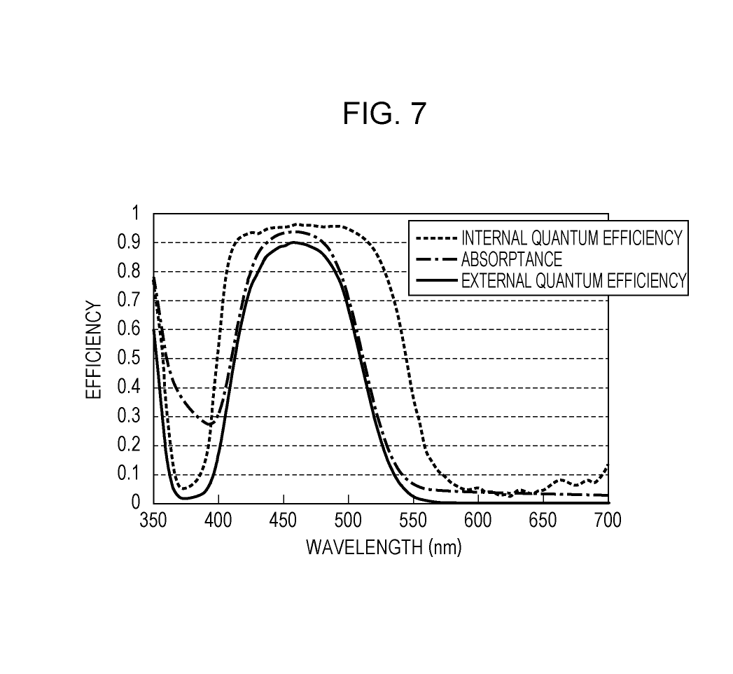

FIG. 7 is a graph showing the external quantum efficiency, absorptance, and internal quantum efficiency of the YAG fluorescent material. As is clear from FIG. 7, the excitation wavelength at which the external quantum efficiency of the YAG fluorescent material is at a maximum is around 450 nm. Accordingly, light having a peak wavelength of 445 nm or 450 nm is generally used to excite the YAG fluorescent material.

With regard to this common general technical knowledge, the inventors of the present invention have focused attention on the fact that reduction in the external quantum efficiency of the YAG fluorescent material is small and the external quantum efficiency can be maintained at a high level when the YAG fluorescent material is excited with a laser beam having a peak wavelength in the range of 430 nm or more and 500 nm or less. The inventors of the present invention have found that, by using a laser beam having a wavelength longer than 450 nm, at which the external quantum efficiency of the YAG fluorescent material is at a maximum, the optical power of the laser beam that excites the YAG fluorescent material can be increased without causing a large reduction in the external quantum efficiency of the YAG fluorescent material while ensuring safety.

Therefore, by exciting the YAG fluorescent material with laser beams which each have a peak wavelength that is longer than 450 nm and shorter than or equal to 500 nm, white illumination light having a high luminous flux can be emitted from the headlamp 1 without causing a large reduction in the external quantum efficiency of the YAG fluorescent material while ensuring safety.

### Operative Example 2

In the case where the fluorescent material included in the light emitting unit 7 is a CASN fluorescent material (CaAlSiN₃:Eu), the peak wavelength of the laser beam emitted from each semiconductor laser 3 is preferably longer than 450 nm and shorter than or equal to 530 nm.

In general, the excitation wavelength at which the external quantum efficiency of the CASN fluorescent material is at a maximum is in the range of 400 nm to 450 nm, and light having a peak wavelength of 450 nm is generally used to excite the CASN fluorescent material.

With regard to this common general technical knowledge, the inventors of the present invention have focused attention on the fact that reduction in the external quantum efficiency of the CASN fluorescent material is small and the external quantum efficiency can be maintained at a high level when the CASN fluorescent material is excited with a laser beam having a peak wavelength in the range of 430 nm or more and 530 nm or less. The inventors of the present invention have found that, by using a laser beam having a wavelength longer than 450 nm, at which the external quantum efficiency of the CASN fluorescent material is at a maximum, the optical power of the laser beam that excites the CASN fluorescent material can be increased without causing a large reduction in the external quantum efficiency of the CASN fluorescent material while ensuring safety.

For example, when the CASN fluorescent material is excited with a laser beam having a peak wavelength longer than 450 nm, the optical power of the laser beam at which the fluorescent material can be excited while achieving Class 1 eye safety according to JIS can be increased by a large amount from that in the case where the fluorescent material is excited with a laser beam having a peak wavelength of 450 nm.

The peak wavelength of the laser beam that excites the CASN fluorescent material is preferably longer than 450 nm and shorter than or equal to 530 nm, more preferably, longer than or equal to 465 nm and shorter than or equal to 530 nm, and most preferably, 470 nm.

The external quantum efficiency of the CASN fluorescent material is substantially constant when the wavelength of the laser beam is 450 nm, 465 nm, or 470 nm. The optical power of the laser beam at which the fluorescent material can be excited while achieving the above-described Class 1 eye safety is about 2 times higher in the case where the wavelength of the laser beam is 465 nm than in the case where the wavelength of the laser beam is 450 nm, and about 2.5 times higher in the case where the wavelength of the laser beam is 470 nm than in the case where the wavelength of the laser beam is 450 nm.

Therefore, by exciting the CASN fluorescent material with laser beams which each have a peak wavelength that is longer than 450 nm and shorter than or equal to 530 nm, white illumination light having a high luminous flux can be emitted from the headlamp 1 without causing a large reduction in the external quantum efficiency of the CASN fluorescent material while ensuring safety.

### Effects of Headlamp 1

As described above, the headlamp 1 includes the semiconductor lasers 3 that emit laser beams and the light emitting unit 7 that receives the laser beams emitted from the semiconductor lasers 3 and generates fluorescent light. The headlamp 1 emits illumination light including the laser beams and the fluorescent light. The peak wavelength of the laser beam emitted from each semiconductor laser 3 is set so as to be longer than a wavelength at which the external quantum efficiency of the fluorescent material is at a maximum.

Thus, the peak wavelength of the laser beam emitted from each semiconductor laser 3 is set so as to be longer than the wavelength at which the external quantum efficiency of the fluorescent material included in the light emitting unit 7 is at a maximum. Accordingly, compared to the case where the fluorescent material is excited with laser beams having an excitation wavelength at which the external quantum efficiency of the fluorescent material is at a maximum, safety of the laser beams can be increased. Therefore, safety of the illumination light can be ensured even when the optical power of the laser beams with which the light emitting unit 7 is irradiated is increased.

Thus, according to the first embodiment, the headlamp 1 can be provided which is capable of emitting illumination light that is safer than that according to the related art even when the optical intensity is constant.

### Second Embodiment

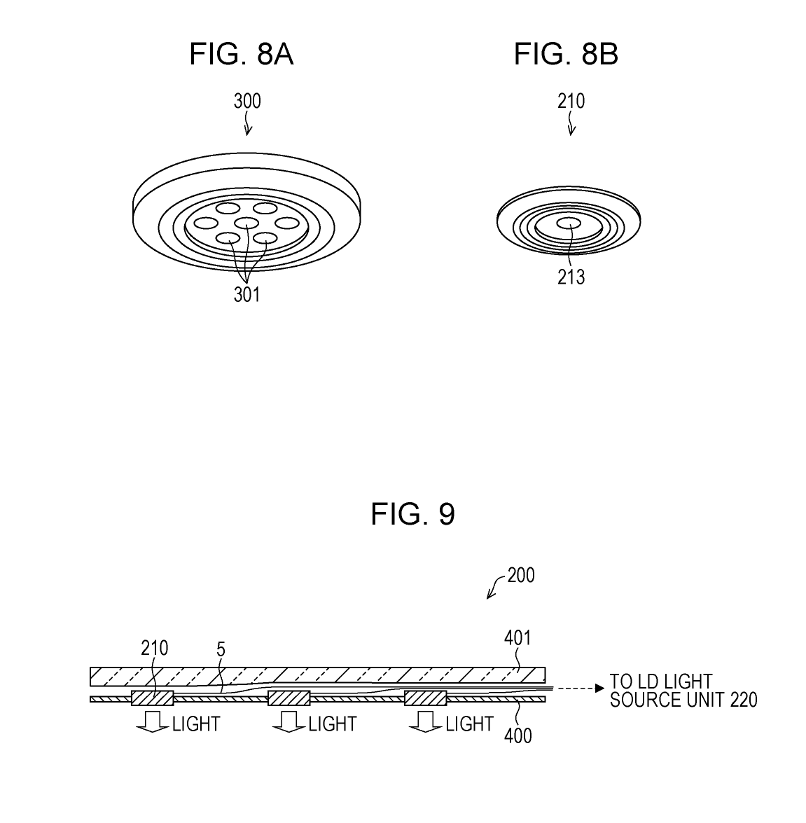

A second embodiment of the present invention will be described below with reference to FIGS. 8A to 12. Components similar to those in the first embodiment are denoted by the same reference numerals, and explanations thereof are thus omitted.

A laser downlight 200 including a light emitting device according to the present invention will be described in the second embodiment. The laser downlight 200 is an illuminating apparatus mounted on a ceiling of a structure such as a house or a vehicle. The laser downlight 200 emits illumination light obtained by mixing a laser beam emitted from a semiconductor laser 3 with fluorescent light obtained as a result of wavelength conversion of a part of the laser beam.

An illuminating apparatus including a device that is similar to the laser downlight 200 may be mounted on a side wall or a floor of a structure. The installation position of the illuminating apparatus is not particularly limited.

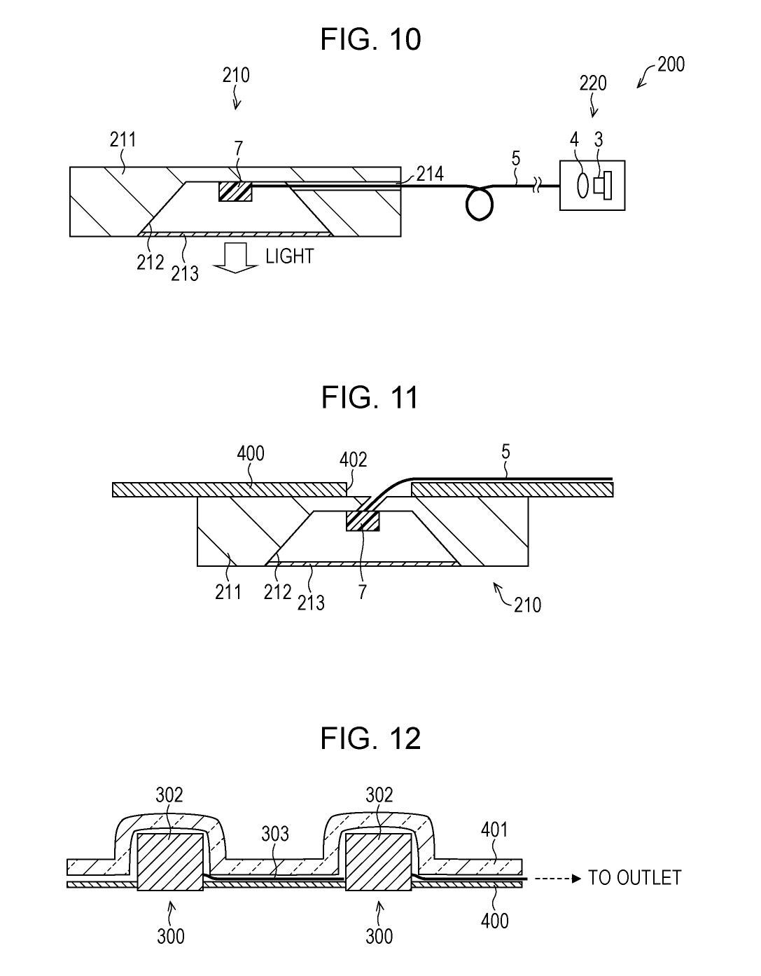

FIG. 8A is a perspective view illustrating the appearance of an LED downlight 300 according to the related art. FIG. 8B is a perspective view illustrating the appearance of a light emitting unit 210. FIG. 9 is a sectional view of the ceiling on which the laser downlight 200 is mounted. FIG. 10 is a sectional view of the laser downlight 200.

As illustrated in FIGS. 8A to 10, the laser downlight 200 includes the light emitting unit 210 that is embedded in a ceiling panel 400 and emits illumination light, and an LD light source unit 220 that supplies a laser beam to the light emitting unit 210 through an optical fiber 5. The LD light source unit 220 is not mounted on the ceiling, but is disposed at a position where a user can easily access (for example, on a side wall of a house). The position of the LD light source unit 220 can be arbitrarily determined because the LD light source unit 220 is connected to the light emitting unit 210 by the optical fiber 5. The optical fiber 5 is disposed between the ceiling panel 400 and a heat insulator 401.

### Structure of Light Emitting Unit 210

As illustrated in FIG. 10, the light emitting unit 210 includes a housing 211, an optical fiber 5, a light emitting unit 7, and a light transmissive plate (filter) 213.

The housing 211 has a recess 212, and a light emitting unit 7 is disposed on the bottom surface of the recess 212. The recess 212 has a thin metal film on a surface thereof, and serves as a reflecting mirror.

The housing 211 has a path 214 that allows the optical fiber 5 to pass therethrough, and the optical fiber 5 extends to the light emitting unit 7 through the path 214. The positional relationship between an outlet end 5a of the optical fiber 5 and the light emitting unit 7 is similar to that described above.

The light transmissive plate 213 is a transparent or semitransparent plate that is arranged so as to block the opening of the recess 212. The light transmissive plate 213 has a function similar to that of the transparent plate 9, and transmits the illumination light emitted from the light emitting unit 7 while removing a part of a wavelength component of the laser beam included in the illumination light, so that highly safe illumination light can be emitted to the outside. The light transmissive plate 213 may be detachable from the housing 211 or be omitted.

Although the light emitting unit 210 has a circular outer edge in FIG. 8, the shape of the light emitting unit 210 (to be precise, the shape of the housing 211) is not particularly limited.

Unlike the headlamp, the downlight is not required to have an ideal point light source, and it is sufficient if the downlight has a single light emitting point. Therefore, limitations on the shape, size, and arrangement of the light emitting unit 7 are less than those in the headlamp.

### Structure of LD Light Source Unit 220

The LD light source unit 220 is provided with the semiconductor laser 3, an aspherical lens 4, and the optical fiber 5.

An inlet end 5b of the optical fiber 5 is connected to the LD light source unit 220, and the laser beam emitted from the semiconductor laser 3 passes through the aspherical lens 4 and enters the optical fiber 5 through the inlet end 5b.

Although a single semiconductor laser 3 and a single aspherical lens 4 are contained in the LD light source unit 220 illustrated in FIG. 10, in the case where a plurality of light emitting units 210 are provided, a bundle of optical fibers 5 that extend from the respective light emitting units 210 may be guided to a single LD light source unit 220. In such a case, a plurality of semiconductor lasers 3 and the respective aspherical lenses 4 (or a plurality of semiconductor lasers 3 and a single rod-shaped lens) are contained in a single LD light source unit 220. Accordingly, the LD light source unit 220 serves as a centralized power supply box.

### Modification of Installation of Laser Downlight 200

FIG. 11 is a sectional view illustrating a modification of the manner in which the laser downlight 200 is installed. Referring to FIG. 11, according to the modification of the manner in which the laser downlight 200 is installed, only a small hole 402 that allows the optical fiber 5 to pass therethrough is formed in the ceiling panel 400. A main body (light emitting unit 210) of the laser downlight 200 may be bonded to the ceiling panel 400 with a piece of strong adhesive tape or the like by taking advantage of the characteristics of the light emitting unit 210 that it is thin and light. In this case, limitations regarding installation of the laser downlight 200 can be reduced, and installation costs can be greatly reduced.

### Comparison Between Laser Downlight 200 and LED Downlight 300 According to Related Art

Referring to FIG. 8A, the LED downlight 300 according to the related art includes a plurality of light transmissive plates 301, and illumination light is emitted through each of the light transmissive plates 301. In other words, the LED downlight 300 includes a plurality of light emitting points.

The reason why the LED downlight 300 includes a plurality of light emitting points is because the luminous flux of the light emitted from each light emitting point is relatively low and light having a sufficient luminous flux as illumination light cannot be obtained unless a plurality of light emitting points are provided.

In contrast, since the laser downlight 200 is a high luminous flux illuminating apparatus, the number of light emitting points may be one. Therefore, an advantage can be achieved in that clear shades can be made by the illumination light. In addition, when a high color rendering fluorescent material (for example, a combination of a plurality of types of oxynitride fluorescent materials) is used as the fluorescent material included in the light emitting unit 7, color rendering properties of the illumination light can be improved.

FIG. 12 is a sectional view of a ceiling on which LED downlights 300 according to the related art are mounted. Referring to FIG. 12, each LED downlight 300 includes a housing 302 which contains an LED chip, a power supply, and a cooling unit and which is embedded in a ceiling panel 400. The housing 302 is relatively large, and a recesses having a shape corresponding to the shape of the housing 302 is formed in a heat insulator 401 in a region where the housing 302 is arranged. A power supply line 303 extends from the housing 302, and is connected to an outlet (not shown).

This structure has the following problems. That is, since the light sources (LED chips) and the power supplies, which are heat sources, are disposed between the ceiling panel 400 and the heat insulator 401, the temperature of the ceiling increases and the efficiency in cooling the room decreases when the LED downlights 300 are used.

In addition, since the light source included in each LED downlight 300 requires a dedicated power supply and a dedicated cooling unit, the total cost increases.

In addition, since the housing 302 is relatively large, it is often difficult to arrange each LED downlight 300 between the ceiling panel 400 and the heat insulator 401.

In contrast, according to the laser downlight 200, the efficiency in cooling the room is not reduced since no large heat source is included in the light emitting unit 210. As a result, the increase in costs for air conditioning in the room can be avoided.

In addition, since it is not necessary to provide a power supply and a cooling unit for each light emitting unit 210, the size, in particular, thickness, of the laser downlight 200 can be reduced. As a result, limitations on the installation space for the laser downlight 200 can be reduced, and the laser downlight 200 can be easily installed in existing houses.

Since the laser downlight 200 is small and thin, the light emitting unit 210 can be mounted on the front side of the ceiling panel 400, as described above, and the light emitting unit 210 substantially requires no installation space on the back side of the ceiling panel 400. Therefore, limitations regarding installation of the laser downlight 200 is smaller than those of the LED downlight 300, and installation costs can be greatly reduced.

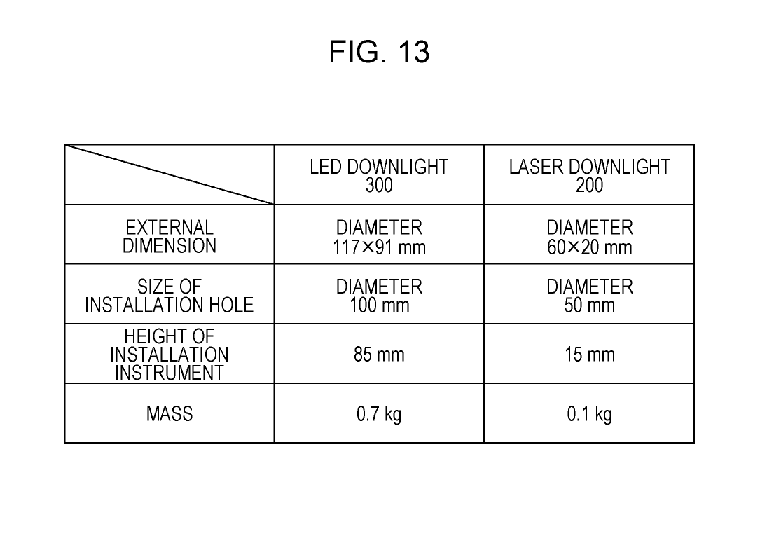

FIG. 13 is a table showing the specifications of the LED downlight 300 and the laser downlight 200. As is clear from FIG. 13, an example of the laser downlight 200 is 94% smaller in volume and 86% lighter in mass than the LED downlight 300.

Since the LD light source unit 220 can be placed at a position (height) where the user's hands can easily access, the semiconductor laser 3 can be easily replaced when it breaks. In the case where a plurality of optical fibers 5 that extend from the respective light emitting units 210 are guided to a single LD light source unit 220, a plurality of semiconductor lasers 3 can be collectively managed. Therefore, even when a plurality of semiconductor lasers 3 are to be replaced, the replacement can be easily performed.

In the case where a high color rendering fluorescent material is used in the LED downlight 300, light having a luminous flux of about 500 lm can be emitted with a power consumption of 10 W. The optical power required to generate light having the same brightness with the laser downlight 200 is 3.3 W. When the LD efficiency is 35%, this optical power corresponds to a power consumption of 10 W. Since the power consumption of the LED downlight 300 is also 10 W, power consumptions of the two downlights do not largely differ from each other. This means that the laser downlight 200 provides the above-described advantages with the same power consumption as that of the LED downlight 300.

As described above, the laser downlight 200 includes the LD light source unit 220 including at least one semiconductor laser 3 that emits a laser beam; at least one light emitting unit 210 that includes the light emitting unit 7 and the recess 212 that serves as a reflecting mirror; and at least one optical fiber 5 that guides the laser beam to the corresponding light emitting unit 210.

Outlet ends 5a of a plurality of optical fibers 5 may be arranged with respect to a single light emitting unit 7 included in the light emitting unit 210. In such a case, the outlet ends 5a are arranged such that regions corresponding to the maximum optical intensity in the optical intensity distributions of the laser beams emitted from the outlet ends 5a are at different locations on the light emitting unit 7.

Also in this laser downlight 200, the peak wavelength of the laser beam emitted from the semiconductor laser 3 may be set to a wavelength longer than the wavelength at which the external quantum efficiency of the fluorescent material included in the light emitting unit 7 is at a maximum. In such a case, compared to the case where the fluorescent material is excited with a laser beam having an excitation wavelength at which the external quantum efficiency of the fluorescent material is at a maximum, safety of the laser beam included in the illumination light can be increased. Therefore, safety of the illumination light can be ensured even when the optical power of the laser beam with which the light emitting unit 7 is irradiated is increased.

Thus, according to the second embodiment, the laser downlight 200 can be provided which is capable of emitting illumination light that is safer than that according to the related art even when the optical intensity is constant.

### Other Embodiments

The present invention is not limited to the above-described embodiments, and various modifications are possible within the scope defined by the claims. Embodiments obtained by combining the technical means disclosed in different embodiments are also included in the technical scope of the present invention.

For example, solid lasers other than semiconductor lasers may be used as excitation light sources. However, semiconductor lasers are preferably used because the excitation light sources can be reduced in size.

### Supplement

A light emitting device according to the present invention may be described as follows. That is, a light emitting device according to the present invention includes an excitation light source that emits excitation light, and a light emitting unit that receives the excitation light and emits fluorescent light. The excitation light source is a laser source that emits a laser beam. The light emitting unit is irradiated with the laser beam and emits the fluorescent light therefrom. The fluorescent light and a part of the laser beam that has not been converted into the fluorescent light by the light emitting unit are mixed so as to form illumination light. The integrated intensity obtained by integrating the optical spectral distribution of the illumination light in a wavelength range of ±5 nm with respect to the oscillation wavelength of the laser beam is 39 μl or less when the oscillation wavelength of the laser beam is shorter than or equal to 450 nm, and is 3.9×10⁻⁵×C₃ (W) (here, C₃=10^{0.02(λ-450)}) or less when the oscillation wavelength is longer than 450 nm and shorter than or equal to 500 nm, more preferably, longer than 450 nm and shorter than or equal to 470 nm.

The present invention is suitable for application to a light emitting device which emits illumination light obtained by mixing a laser beam with fluorescent light obtained as a result of wavelength conversion of a part of the laser beam.

What is claimed is:

1. A light emitting device comprising:
a laser source that emits a laser beam; and
a light emitting unit including a fluorescent material that receives the laser beam emitted from the laser source and emits fluorescent light,
wherein the light emitting device emits illumination light including the laser beam and the fluorescent light, and
wherein a peak wavelength of the laser beam emitted from the laser source is longer than a wavelength at which an external quantum efficiency of the fluorescent material is at a maximum.

2. The light emitting device according to claim 1, wherein the fluorescent material is a YAG fluorescent material, and
wherein the peak wavelength of the laser beam is longer than 450 nm and shorter than or equal to 500 nm.

3. The light emitting device according to claim 1, wherein the fluorescent material is a CASN fluorescent material, and
wherein the peak wavelength of the laser beam is longer than 450 nm and shorter than or equal to 530 nm.

4. The light emitting device according to claim 1, wherein, when the peak wavelength of the laser beam is longer than 450 nm and shorter than or equal to 500 nm, an integrated intensity of optical spectrum of the illumination light in a wavelength range of ±5 nm with respect to the peak wavelength of the laser beam is 3.9×10⁻⁵×C₃ W or less, where C₃=10^{0.02×(λ-450)} when the peak wavelength of the laser beam is λ nm.

5. The light emitting device according to claim 1, further comprising:
a filter member that transmits the illumination light while removing a part of a wavelength component of the laser beam included in the illumination light.

6. An illuminating apparatus comprising:
the light emitting device according to claim 1.

7. A light emitting method for a light emitting device including a laser source that emits a laser beam and a light emitting unit including a fluorescent material that receives the laser beam emitted from the laser source and emits fluorescent light, the light emitting device emitting illumination light including the laser beam and the fluorescent light, the light emitting method comprising:
exciting the fluorescent material with the laser beam that has a peak wavelength longer than a wavelength at which an external quantum efficiency of the fluorescent material is at a maximum.
